(19) United States
(12) Patent Application Publication
(10) Pub. No.: US 2007/0218287 A1
(43) Pub. Date: Sep. 20, 2007

(54) Coatings for affecting spectral performance of photonic devices in optical applications and methods of manufacture

(75) Inventor: Jamie Knapp, Mendon, MA (US)

Correspondence Address: MARJAMA & BILINSKI LLP, 250 SOUTH CLINTON STREET, SUITE 300, SYRACUSE, NY, 13202, US

(73) Assignee: Newport Corporation, Irvine, CA (US)

(21) Appl. No.: 11/374,908

(22) Filed: Mar. 14, 2006

(51) Int. Cl. B32B 27/18; B05D 5/06; B32B 9/04; B05D 3/06

(52) U.S. Cl. 428/411.1; 427/162; 427/557; 427/558

(57) ABSTRACT

Single layer, fluidic polymer-based coatings are provided for application or deposition onto a target surface of a photonic device, whereby the coating is formed of one or more spectral tuning materials so as to absorb infrared, ultraviolet or infrared and ultraviolet wavelength that might otherwise be present as background and would interfere with the performance of the photonic device in optical applications.

### BACKGROUND

Photonic devices such as semiconductor-based photosensors and photoemitters are routinely used for optical applications. In general, the spectral responsivity of such devices can be quite wide, even extending to the optical absorption edge of the semiconductor material from which the device is made. For example and as shown in FIG. 1, in the case of photonic devices that incorporate intrinsic silicon, such responsivity increases linearly with wavelength up to a peak occurring around 1000 nm, beyond which it decreases until essentially disappearing at about 1200 nm.

However, this large range of spectral responsivity actually can be suboptimal when such devices are used within more narrow spectral ranges. For example, for use in visible applications from about 400 nm to about 700 nm the infrared wavelengths above about 700 nm are a major source of disadvantageous, interfering background irradiance. Although those in the art have sought to suppress such background infrared irradiance, their current techniques for doing so—namely, reflectance or absorptance techniques—have proven to be replete with problems.

At present, suppression via spectral reflectance is most commonly achieved through use of multi-layer dielectric optical coatings, which reflect away undesirable infrared wavelengths above about 700 nm by optical interference. Such dielectric optical coatings may be deposited directly onto one or more surfaces of a photonic device, or they can be deposited as discreet optical filter coatings onto a glass or other rigid substrate, which is subsequently incorporated physically into the semiconductor device.

Utilizing either approach tends to cause significant problems with a device's telecentricity, which, in turn, can prevent the device from being employed in photometric imaging applications for accurate metrology. In addition, multi-layer coatings are often highly stressed, which can lead to the formation of performance-degrading defects.

Discreet optical filter coatings are disfavored because they are cost prohibitive and unduly labor intensive to employ. However, direct deposition is likewise problematic—that is, currently utilized direct deposition techniques (e.g., thermal evaporation, ion-beam or magnetron sputtering, ion-assisted e-beam deposition, reactive ion plating) are highly complex and costly. Moreover, even if performed correctly, such techniques can cause damage to a photonic device due to conditions (e.g., high deposition temperatures, exposure to X-rays or energetic ions) present during the deposition process. Also, if a multi-layer dielectric coating is deposited directly onto a photonic device, the electrical interface characteristics of the device can be negatively affected (e.g., the passivation properties of the device are degraded). That, in turn, can lead to loss of responsivity and an elevation of dark-current (i.e., increased background noise). Directly deposited multi-layer optical coatings also may absorb sufficient moisture (due to, e.g., inherent film porosity) to increase electrical conductivity to an extent whereby device performance is negatively affected. Moreover, processing of such devices after multi-layer coatings are directly deposited thereupon requires photolithography processing steps to “etch” windows into the hard, glass-like coatings in order to create the openings required for electrical contacts. At present, such processing is performed chemically (e.g., using hydrofluoric acid) or physically (e.g., via ion-beam milling), both of which are costly, complex and oftentimes unsuccessful options.

Suppression via absorptance avoids some of the problems associated with the aforementioned reflectance techniques, but is hindered by still other drawbacks. The colored absorptive glasses employed in accordance with such techniques must be very thick (i.e., greater than 2 mm) in order to adequately absorb the background infrared irradiance. Consequently, they are very expensive and have limited availability. Also, such glasses suffer from significant variability—that is, the properties of one glass may be at least somewhat different from those of another. Moreover, the glasses tend to be environmentally unstable, such that when exposed to standard temperatures and humidities their surfaces can decompose and become optically opaque over time. This leads to a reduction in their transparency, which, in turn, causes a subsequent loss of device responsivity.

Therefore, a need exists for devices and techniques to tune or otherwise affect the spectral performance of photonic devices, including, at minimum, to reliably suppress background infrared irradiance that otherwise interferes with performance of the photonic devices in visible wavelength applications, and whereby such devices and techniques do not encounter the various problems and drawbacks that have plagued prior art approaches.

### SUMMARY

The coatings and coating architectures described in the present application meet these and other needs by affecting the spectral performance of a photonic device, whereby the coatings are applied or deposited either directly onto one or more application surfaces of the photonic device and/or onto one or more surfaces of the packaging of the photonic device. In one embodiment, the coatings are configured to alter the spectral performance of the photonic device through optical absorption of undesirable infrared and/or ultraviolet wavelengths, thus eliminating background interference and enabling the device to more optimally perform in various important optical applications within visible wavelengths.

In one embodiment, the present application is directed to a photonic device and includes at least one coating application surface or area onto which a coating is applied. The coating application surface/area can be, e.g., one or more optically active surfaces of the photonic device and/or one or more windows of the photonic device.

Optionally, the coating may comprise a polymeric and self-leveling material. In one embodiment, the coating is in fluid form (i.e., fluidic) when applied to the photonic device. The coating may comprise at least one spectral altering or tuning material that is effective to absorb at least a wavelength range selected from the group consisting of (a) infrared irradiance, (b) ultraviolet irradiance, and (c) infrared irradiance and ultraviolet wavelength. The at least one spectral tuning material can be, e.g., a dye. The coating can include other materials as well, such as at least one solvent carrier.

In another embodiment, the present application discloses a method of tuning a photonic device and recites providing a photonic device, providing a coating comprising at least one spectral tuning material effective to absorb at least infrared irradiance, and applying a coating onto at least one predetermined area of the photonic device. Optionally, the coating can include other materials as well, such as at least one solvent carrier.

In another embodiment, the present application is directed to a method of tuning the spectral performance of a photonic device and recites providing a photonic device, combining at least one spectral tuning material and at least one solvent carrier, wherein each of the at least one spectral tuning material is effective to absorb a wavelength range selected from the group consisting of (a) infrared irradiance, (b) ultraviolet irradiance, and (c) infrared irradiance and ultraviolet wavelength, and applying the combined at least one spectral tuning material and at least one solvent carrier to form a coating onto at least one predetermined area of the photonic device.

In accordance with these, and, if desired, other exemplary spectral performance affecting methods, the coating is polymeric, self-leveling, and is in fluid form (i.e., fluidic) when applied. The predetermined area of the photonic device on which the coating is applied can be, e.g., an optically active surface of the photonic device and/or a window of the photonic device. The coating can be applied to the at least one predetermined area via a manual technique, or by a non-manual technique, e.g., though use of an automatic metering needle dispenser. The applied coating is cured or allowed to cure for a predetermined time (e.g., about one hour) at a predetermined temperature (e.g., about room temperature). The at least one spectral tuning material can be, e.g., a dye.

Still other aspects, embodiments and advantages of the coatings and methods of manufacture are discussed in detail below. Moreover, it is to be understood that both the foregoing general description and the following detailed description are merely illustrative examples of various optical coatings, and are intended to provide an overview or framework for understanding the nature and character of the invention as it is claimed. The accompanying drawings are included to provide a further understanding of the various embodiments of the coatings and methods of manufacture described herein, and are incorporated in and constitute a part of this specification.

### BRIEF DESCRIPTION OF THE DRAWINGS

For a fuller understanding of the nature and desired objects of the various embodiments of the coatings and methods of manufacture as described herein, reference is made to the following detailed description, which is to be taken in conjunction with the accompanying drawing figures wherein any like reference characters denote corresponding parts throughout the several views presented within the drawing figures, and wherein:

FIG. 1 is a graph of responsivity versus wavelength for a silicon-based photonic device;

FIG. 2 is a schematic front view of an exemplary photonic device having a top surface on which a coating has been applied or deposited;

FIG. 3 is a schematic front view of an exemplary photonic device having a packaging window onto the exterior of which a coating has been applied or deposited; and

FIG. 4 is a graph of responsivity versus wavelength for a silicon-based photonic device after a coating has been applied or deposited thereupon.

### DETAILED DESCRIPTION

The present application discloses devices and methods for affecting (e.g., tuning) the spectral performance of a photonic device through use of one or more coatings applied or deposited either directly onto an application surface of the device or onto one or more surfaces of its packaging (e.g., onto its interior and/or exterior window(s)). In particular, the coating(s) alter or tune the spectral performance of the photonic device through optical absorption of the infrared portion and/or ultraviolet portion of the electromagnetic spectrum, thus eliminating background interference and enabling the device to more optimally perform in various important optical applications within the visible portion of the spectrum.

As used herein, the phrase “photonic device” refers to a device utilized within a light-based, optical and/or laser application. Exemplary photonic devices include, but are not limited to chips, dies, photosensors and photo-emitters, wherein such devices generally, but not necessarily, are formed entirely or partially of one or more semiconductor materials such as silicon. Also, the terms “infrared,” “visible” and “ultraviolet,” as used herein with regard to the electromagnetic spectrum, refer to the portion of the spectrum between about 700 nm and about 1000 nm (“infrared”), between about 400 nm and about 700 nm (“visible”), and between about 10 nm and 400 nm (“ultraviolet”).

In one embodiment, a coating is applied or deposited onto an application surface. The coating may be applied to the application surface as a single layer. In an alternate embodiment, the coating also can have more than one layer. Similarly, the coating may be applied to the application surface in fluidic form or in non-fluidic form. The coating can be applied or deposited through use of various techniques, including, by way of non-limiting example, manual techniques (e.g., via a drop-on technique) or non-manual techniques (e.g., by means of an automatic metering needle dispenser), each as is known in the art.

The coating may comprise any variety of materials. For example, the coating may be at least partially a polymer-based (i.e., polymeric) material. Further, the coating may be comprised of one or more materials. Optionally, the coating may include at least one material that is configured to absorb unwanted background infrared irradiance and/or ultraviolet wavelengths. For example, at least one material within the coating may be configured to absorb either (a) infrared irradiance, (b) ultraviolet wavelength, or (c) both infrared irradiance and ultraviolet wavelength.

In another embodiment, the coating may be comprised of more than one spectral tuning material. For example, the coating may include at least one additional material selected to hold one or more spectral tuning materials within a coating material in suspension, thereby facilitating the formation of a homogeneous mixture. By way of non-limiting example, the at least one additional material can be a solvent carrier, which either substantially or entirely dissolves after causing the spectral tuning materials to be formed into the coating. Optionally, any variety of alternate or additional materials may be used, including, without limitation, curing agents, hardeners, dyes, coloring agents, and the like.

In one embodiment, the coating is comprised of two or more different spectral tuning materials, each of which is effective not only to absorb both ultraviolet and infrared wavelength but also to pass through visible wavelength. Suitable such materials include, but are not limited to, dyes such as heptyl acetate and cyclohexanone, each of which is commercially available in powder form from various entities such as Epilon, Inc. of Newark, N.J. USA. For these dyes, an exemplary solvent carrier is solvent naphtha. Optionally any variety of alternate solvent carriers can be used in lieu of solvent naphtha either in combination with the same or different spectral tuning materials.

During use, once the various materials that comprise the coating have been mixed or otherwise combined, the coating(s) is applied or deposited onto at least one surface of the photonic device, after which the application surface is cured or allowed to cure, during which time the solvent carrier evaporates to leave behind a hardened isotropic coating formed of the one or more spectral tuning materials. As noted above, exemplary coating application/deposition techniques include, but are not limited to manual techniques (e.g., drop-on techniques) or non-manual techniques (e.g., automatic metering needle dispenser), none of which, as is currently preferred, require the use of expensive vacuum and/or plasma equipment.

Forming the coating from a combination of the one or more spectral tuning materials and solvent carrier is advantageous because these materials are low cost and cause the formed coating to be isotropic in its optical and/or physical properties. Moreover, each of the spectral tuning materials generally has low surface tension and low viscosity, thus enabling the coating to be self-leveling and easy to apply or deposit evenly onto a surface without requiring additional photolithography steps as are normally performed when applying or depositing multi-layer coatings. The presence of the one or more spectral tuning materials also enables the formed coating to be environmentally stable and resistant to decomposition when exposed—even for a long duration—to standard temperatures and humidities.

Thus, the coatings of the present application have several important advantages versus both prior art multi-layer optical coatings utilized in reflectance techniques and colored glasses used in prior art absorptance techniques. At least some of these various advantages are summarized in TABLE 1 below:

TABLE 1

| | | Multi-Layer | |
|---|---|---|---|
| | | Optical Coatings | Colored Glasses |
| | Coatings of | used in prior art | used in prior art |
| | the Present | Reflectance | Absorptance |
| | Invention | techniques | techniques |
| Application | Simple | Complex, expensive | Complex application |
| of Coating | application | application | process requires |
| | process | process occurring | mounting and |
| | occurring | in “clean-room” | bonding of the |
| | at room | using vacuum and | coating to the |
| | temperature | plasma equipment | semiconductor |
| | | | surface or housing |
| Cost | Cost to cover | Cost to cover | Cost to cover |
| | 6 mm² area is | 6 mm² area is | 6 mm² area is |
| | about $0.0095 | about $2.87 | about $1.75 |
| Thickness | Thin | Very Thin | Thick |
| | (˜0.1 mm) | (1-10 microns) | (>2 mm) |
| Other | Low stress; | Very high stress; | Tend to decompose |
| factors | no post- | complex post- | over time due to |
| | processing | deposition photo- | environmental |
| | required; | lithography and | instability; lot- |
| | permanently | etching required; | to-lot variability |
| | hermetically | potential | |
| | seals | degradation of | |
| | surfaces | device performance | |
| | | over time due | |
| | | to various factors | |

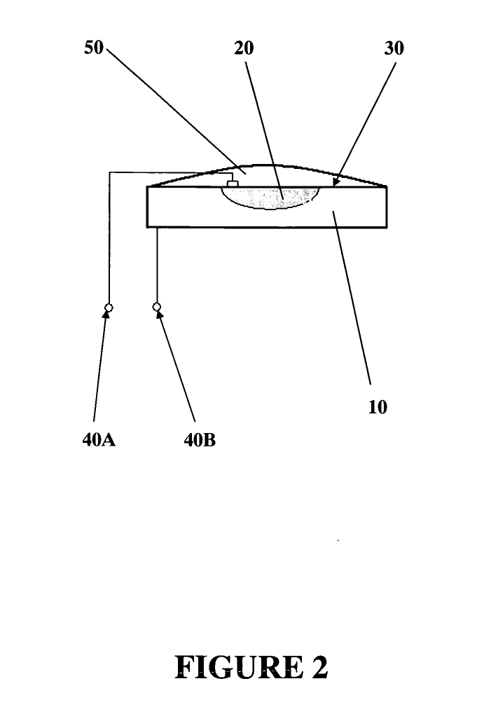

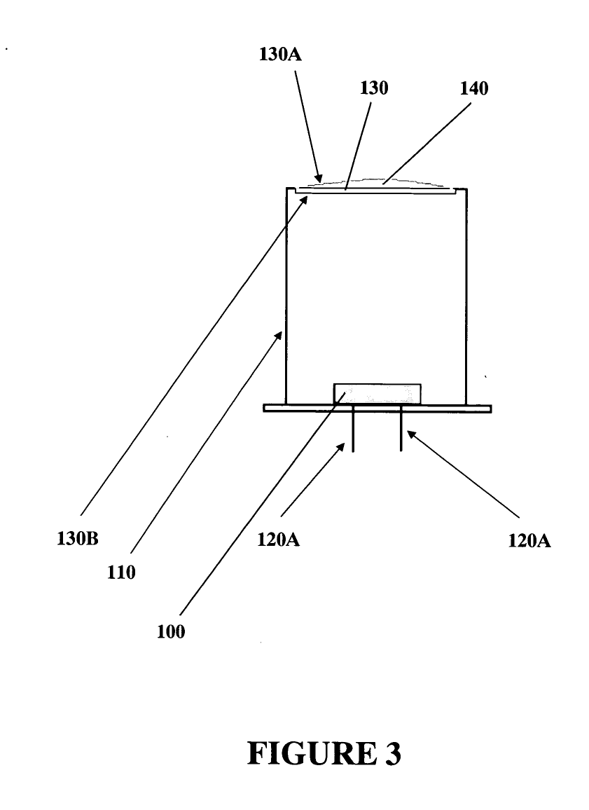

As noted above, the coatings described herein may be applied or deposited in fluid form as a single layer. Optionally, the coatings may be applied in a non-fluidic form and/or may comprise a multiple layer coating. As applied/deposited, the coatings are configured to be effective to tune the spectral performance of a photonic device through absorption of infrared and/or ultraviolet wavelengths. The coatings can be applied or deposited onto an optically active surface of a photonic device, as shown in FIG. 2, or, alternatively, onto the surface of an interior and/or exterior window of the packaging of a photonic device, as shown in FIG. 3.

FIG. 2 depicts a photonic device 10 having an optically active area 20 on its top surface 30, wherein the optically active area extends into the device. The illustrated photonic device 10 can be, by way of non-limiting example, a silicon chip; however, it is understood that the FIG. 2 embodiment is applicable to other photonic devices as well without undue experimentation. A plurality of electrical contacts 40A, 40B are provided in communication with the chip 10. As shown in FIG. 2, at least one contact 40A may be disposed on the top surface 30 of the chip 10.

As illustrated in FIG. 2, a coating 50 of the type described hereinabove has been applied or deposited onto the top surface 30 of the photonic device 10 using an above-described technique. In one embodiment, the coating, as formed, provides a hermetic seal on the top surface of the device, including over the optically active area 20 and the electrical contact 40A. Optionally, the coating 50 need not form a hermetic seal on the top surface. In the illustrated embodiment, the coating 50 comprises a single layer coating 50. Optionally, a multiple layer coating may be applied to the device. As noted above in TABLE 1, the thickness of the applied/deposited coating generally is about 0.1 mm. In another embodiment, the thickness of the coating 50 is about 0.001 μm to about 100 mm.

FIG. 3 depicts a photonic device 100 within a housing 110, wherein the photonic device includes a plurality of protruding electrical leads 120A, 120B. The illustrated photonic device 100 can be, by way of non-limiting example, a semiconductor die; however, it is understood that the FIG. 3 embodiment is applicable to other photonic devices as well without undue experimentation. The housing 110 has a top surface/window 130, wherein a coating 140 of the type described hereinabove has been applied or deposited onto the exterior 130A of the window using an above-described technique, and wherein the coating hermetically seals the top surface.

Although FIG. 3 depicts a coating 140 having been applied solely to the exterior 130A of a window 130 of the photonic device 100, it is also possible to apply/deposit a coating onto the interior 130B of the window of the device in lieu of or in addition to the coating on the window exterior. The thickness of each layer of coating, as applied/deposited, generally is about 0.1 mm, but can be greater or less, if desired. Exemplary coating thicknesses range from about 0.001 μm to about 100 mm.

The coating of the present application also can be utilized to coat a entire semiconductor wafer, as opposed just a discreet photonic device (e.g., the chip 10 shown in FIG. 2 or the die 100 depicted in FIG. 3) formed of a portion of such a wafer. For example, the wafer may comprise a silicon wafer having a transverse dimension of about 0.01 inch to about 100 inches. In one embodiment, the wafer has a transverse dimension of about 4.0 inches to about 8.0 inches. It is understood, however, that other “large scale” targets can be coated and can have sizes outside of this range.

In one embodiment, the coating applied/deposited onto the semiconductor wafer generally is a single-layer, fluidic coating comprised of the same combination of materials as the coatings described hereinabove. Optionally, the coating may comprise a multiple layer and/or non-fluidic coating. Also, various techniques can be used to apply/deposit the coating onto the wafer, such as those noted above, as well as other techniques including, but not limited to, “spinning,” which calls for injecting or otherwise introducing the fluidic coating onto the surface of the wafer while the wafer is being rotated.

Once coated, the wafer is cured or allowed to cure, after which the wafer may be cut, diced or otherwise separated into segments, which may be mounted within their appropriate housings. For backside illuminated applications, the coating may be applied or deposited onto the rear surface of the wafer. For front-side illuminated applications, one or more windows or other openings are defined through the coated surface of the wafer in order to produce the electrical contacts onto the surface of the wafer. These openings/windows can be defined within the wafer using a technique known in the art, such as ion-beam milling or chemical etching (e.g., via methyl ethyl ketone).

### EXAMPLE

A silicon-based complementary metal oxide semiconductor (CMOS) photosensor die having an optically active area of 6 mm×6 mm was mounted within a removable window detector housing. The window was then removed and the photosensor active surface was coated with a mixture of heptyl acetate dye, cyclohexanone dye and solvent naphtha using an automatic metering needle dispenser. The coated photosensor was allowed to cure at room temperature for one hour, during which time the solvent naphtha evaporated to leave behind a single-layer, hardened coating having a thickness of about 0.1 mm and being spread evenly over the entire or substantially the entire active surface of the photosensor.

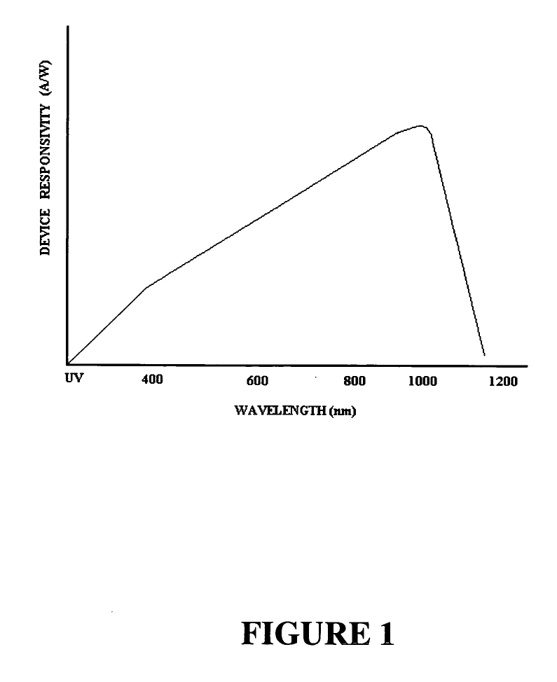

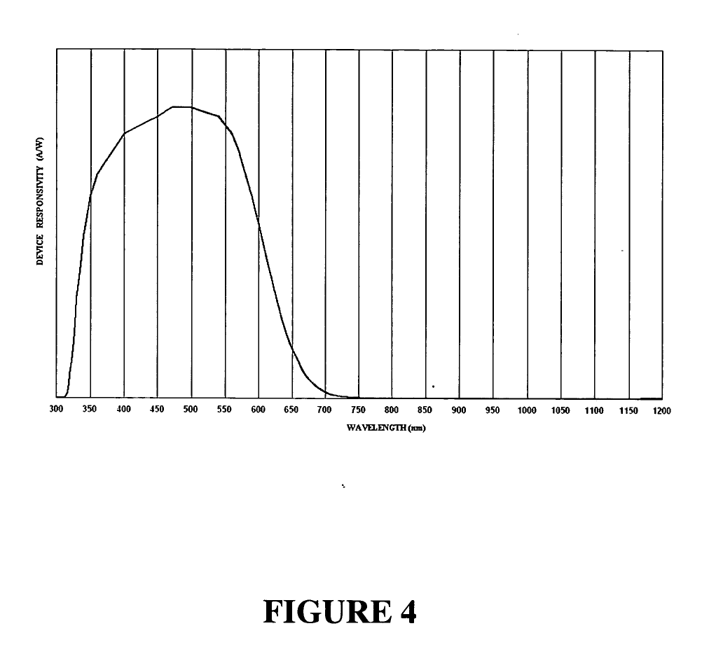

The spectral performance of the coated photosensor was then analyzed. As shown by the graph in FIG. 4, the coating was effective to tune the photosensor to exhibit maximum responsivity between about 450 mm and 500 mm, which is within the visible wavelength range important for many optical applications. Moreover, there was almost no responsivity beyond 700 nm, thus indicating the coating was effective to eliminate the undesirable infrared irradiance (i.e., responsivity over 700 nm) that, as shown in FIG. 1, would otherwise be present if the coating had not been applied/deposited.

Thus, a coating described herein is highly advantageous because its presence effectively suppresses or tunes out the background irradiance that otherwise inhibits optimal performance of photonic devices, e.g., performance for optical applications within the visible wavelength range.

Although coatings and manufacture methods have been described herein with reference to details of currently preferred embodiments, it is not intended that such details be regarded as limiting the scope of the invention, except as and to the extent that they are included in the following claims—that is, the foregoing description of the embodiments of the coatings and manufacturing methods are merely illustrative, and it should be understood that variations and modifications can be effected without departing from the scope or spirit of the invention as set forth in the following claims. Moreover, any document(s) mentioned herein are incorporated by reference in their entirety, as are any other documents that are referenced within the document(s) mentioned herein.

What is claimed:

1. A photonic device, comprising:
at least one coating application surface; and
at least one coating applied atop the coating application surface, the coating comprising at least one spectral tuning material effective to absorb at least infrared irradiance.

2. The photonic device of claim 1, wherein the coating is fluidic as applied.

3. The photonic device of claim 1, wherein the coating is polymeric.

4. The photonic device of claim 1, wherein the at least one spectral tuning material is effective to absorb infrared irradiance and ultraviolet wavelength.

5. The photonic device of claim 1, wherein the coating further comprises a solvent carrier.

6. The photonic device of claim 1, wherein the at least one spectral tuning material is a dye.

7. The photonic device of claim 1, wherein the coating includes a plurality of spectral tuning materials.

8. The photonic device of claim 7, wherein each of the plurality of spectral tuning materials is effective to absorb at least a wavelength range selected from the group consisting of (a) infrared irradiance, (b) ultraviolet irradiance, and (c) infrared irradiance and ultraviolet wavelength.

9. The photonic device of claim 1, wherein the application surface is selected from the group consisting of (a) an optically active surface of the photonic device, and (b) a window of the photonic device.

10. The photonic device of claim 1, wherein the coating is self-leveling as applied.

11. The photonic device of claim 1 wherein the coating is applied to the photonic device as a single layer.

12. A method of tuning the spectral performance of a photonic device, comprising the steps of:
providing a photonic device;
providing at least one coating comprising at least one spectral tuning material effective to absorb at least infrared irradiance; and
applying the coating onto at least one predetermined area of the photonic device.

13. The method of claim 12, wherein the predetermined area is selected from the group consisting of (a) an optically active surface of the photonic device, and (b) a window of the photonic device.

14. The method of claim 12, wherein the coating is fluidic as applied.

15. The method of claim 12, wherein the coating is polymeric.

16. The method of claim 12, further comprising a solvent carrier.

17. The method of claim 12, wherein each of the at least one spectral tuning material is effective to absorb at least a wavelength range selected from the group consisting of (a) infrared irradiance, (b) ultraviolet irradiance, and (c) infrared irradiance and ultraviolet wavelength.

18. The method of claim 12, wherein the coating is applied to the at least one predetermined area via a manual technique.

19. The method of claim 12, wherein the coating is applied to the at least one predetermined area via a non-manual technique.

20. The method of claim 19, wherein the coating is applied to the at least one predetermined area though use of an automatic metering needle dispenser.

21. The method of claim 12 wherein the coating comprises a single layer coating.

22. A method of tuning the spectral performance of a photonic device, comprising the steps of:
providing a photonic device;
combining at least one spectral tuning material and at least one solvent carrier, wherein each of the at least one spectral tuning material is effective to absorb at least a wavelength range selected from the group consisting of (a) infrared irradiance, (b) ultraviolet irradiance, and (c) infrared irradiance and ultraviolet wavelength; and
applying the combined at least one spectral tuning material and at least one solvent carrier to form a coating onto at least one predetermined area of the photonic device.

23. The method of claim 22, wherein the coating is fluidic as applied.

24. The method of claim 22, further comprising the step of allowing the fluidic applied coating to cure for a predetermined time at a predetermined temperature.

25. The method of claim 24, wherein the predetermined time is about one hour and the predetermined temperature is about room temperature.

26. The method of claim 22, wherein the coating is self-leveling.

27. The method of claim 22, wherein the predetermined area is selected from the group consisting of (a) an optically active surface of the photonic device, and (b) a window of the photonic device.

28. The method of claim 22, wherein the coating is polymeric.

29. The method of claim 22, wherein the coating is applied to the at least one predetermined area via a manual technique.

30. The method of claim 22, wherein the coating is applied to the at least one predetermined area via a non-manual technique.

31. The method of claim 30, wherein the coating is applied to the at least one predetermined area though use of an automatic metering needle dispenser.

32. The method of claim 22 wherein the coating comprises a single layer coating.
